(19) United States
(12) Patent Application Publication
(10) Pub. No.: US 2024/0002174 A1
(43) Pub. Date: Jan. 4, 2024

(54) TRANSPORT AND LOADING ASSEMBLY FOR A MOTOR VEHICLE

(71) Applicant: Knut MARTIN, Pfinztal (DE)

(72) Inventor: Knut MARTIN, Pfinztal (DE)

(21) Appl. No.: 18/038,297

(22) PCT Filed: Oct. 28, 2021
(86) PCT No.: PCT/EP2021/079973

§ 371 Date: May 23, 2023

(30) Foreign Application Priority Data
Nov. 27, 2020 (DE) 10 2020 131 525.2

(51) Int. Cl. B65G 67/02; B66F 9/065; G05D 3/12; B66F 9/24

(52) U.S. Cl. CPC B65G 67/02; B66F 9/065; G05D 3/12; B66F 9/24

(57) ABSTRACT

A transport and loading assembly for a motor vehicle, such as a passenger car in particular, includes a loading area extending to a rear opening. The transport and loading assembly has a transport cart which has a chassis with multiple adjustable rollers and at least one transport container, wherein the chassis can be adjusted between a transport position and a loading position. The transport and loading assembly also has a loading device which can be installed in the loading area and which has a loading mechanism for loading and/or unloading the transport cart into or out of the loading area. The transport cart has an electrically operated height adjustment device, by means of which the height of the transport cart can be adjusted in the transport position. The chassis has an at least partly telescoping linkage in order to adjust the height of the transport cart and three rollers are held on a respective telescoping device, wherein the telescoping devices can be adjusted independently of one another.

The invention relates to a transport and loading assembly for a motor vehicle, such as a passenger car in particular, comprising a loading area extending to a rear opening, such as in the form of a tailgate, a rear door or a trunk lid, according to the generic concept of claim 1, as well as to a transport cart, a loading device for such a loading assembly and a loading method using the transport and loading assembly. The passenger car can be designed, for example, as a station wagon, high-roof station wagon, SUV, pickup, van, minivan, hatchback or sedan. In this case, the transport and loading assembly has a transport cart comprising a chassis with multiple rolling means and at least one fixed or removable or replaceable transport container. The transport container can be formed, for example, by a basket, a container, a cool box, a child seat receiving area, a tool receiving area or the body of a tool trolley, workshop trolley, craftsman's trolley and/or a receiving area for leisure equipment. The chassis or the transport cart as a whole can be adjusted between a transport position, in which the transport cart can be placed on a base surface and moved for transporting objects received, and a loading position, in which the chassis and/or the transport cart as a whole has minimized external dimensions for easier loading and stowing in the loading area. Furthermore, the transport and loading assembly has a loading device which is provided for accommodation or fastening in the loading area of the motor vehicle and which comprises a loading mechanism. The loading mechanism is used for at least partially automatic loading of the transport car into the loading area and/or unloading of the transport cart from the loading area. In this case, the transport cart has a height adjustment device by means of which a height of the transport cart or a vertical distance of the transport container relative to the rolling means can be set, in particular steplessly or at least multiply stepped, in order to be able to set a predetermined docking position and/or support position, different from the transport position and the loading position, relative to the loading device, from which an at least partially automatic loading operation can be carried out by means of the loading device. Multiple stepping is when the height of the transport container can be adjusted between a maximum and a minimum height setting in at least five, preferably ten, intermediate steps. For this purpose, the height adjustment device can have a height-adjustable mechanism, for example, on the chassis and/or on the transport container. The vertical adjustment can be formed, for example, by linearly displaceable, pivotable, screw-like rotatable, telescoping, scissor- or knee-joint-like means and/or all other known and suitable means for manual, partially automatic or fully automatic height adjustment, which is driven, for example, manually, mechanically, hydraulically and/or electrically. This means that the height of the transport cart or its transport container can be adapted very precisely to the rear opening or to the loading device accommodated in the loading area In addition to the transport position and the loading position, the possibility of dividing the loading position and the support position ensures that the loading device can pick up the transport cart safely and load it into the loading area automatically without any problems.

DE10043398A1 discloses a system for loading a vehicle, in which a lift truck can be connected to a receiving device in the loading area of a vehicle via a coupling device. The lift truck has a transport container and a rigid chassis, the distance between which can be adjusted. For loading, the transport container is adjusted to a suitable height and displaced to a parking area of the vehicle. The chassis is then raised to a position above the loading area so that the lift truck can be moved completely into the loading area. In an alternative embodiment, a telescoping lift truck is used, which is pushed onto a loading area via the transport container's own rollers, while the chassis is partially folded and partially displaced to the position above the loading area by means of a telescoping device.

DE102016114310A1 discloses a load cart having a receiving area adjustably supported on a chassis. The height of the receiving area can be adjusted relative to the chassis so that it can be pushed onto a loading area. Once the receiving area is set on the loading area, the chassis can then be folded around the receiving area into a folded position.

US2006/0061116A1 shows an extendable equipment table for use on a pickup truck. The equipment table can be displaced away from a loading area via extendable loading rails and then placed and moved on a base surface via fold-out and height-adjustable legs.

DE102019212501A1 discloses a commercial vehicle with a load floor in which a transport cart is integrated in such a way that it forms a common loading area with the load floor. The transport cart has a height-adjustable, fold-out chassis.

DE19521549A1 describes a holding device with two rails provided on a loading area, on which a receiving area frame can be loaded. Folding legs are provided on the frame, which are folded out when unloading and folded in when loading.

US2014/0356112A1 shows a pickup truck with loading rails by means of which a transport cart can be held and pushed from a loading area. A chassis can then be extended on the transport cart held by the loading rails, the chassis being height-adjustable via a scissor joint. Via the height-adjustable chassis, the transport cart can be moved on a base surface and can be received again from the loading rails once the appropriate height has been set.

US2019/0235508A1 describes an autonomous delivery vehicle on which a movable receiving container can be loaded and unloaded, which has retractable legs for this purpose.

DE102014016905A1 discloses a receiving frame which can be loaded on a rail system of an ambulance and has a fold-in chassis.

US2002/0149176A1 shows a collapsible transport cart on which four wheels are each held on a telescoping device. In order to carry out a loading operation, the wheels are thereby height adjustable in pairs.

From DE102015220655A1 a transport and loading system is known which is intended to make the loading of loads easier and more convenient, such as in particular shopping. In addition, the aim is to avoid the need for the usual transfer of loads from a shopping cart to the trunk. For this purpose, the transport cart has a frame that can be folded and unfolded. Further, a conveyor belt, plate, and/or frame is provided that is movable out from under the transport container to pick it up and load it into the trunk automatically.

A disadvantage of the known transport and loading system is that widely differing alignments of the transport cart relative to the loading device can occur, particularly in the case of an uneven base surface, which prevent the transport cart from being picked up on the conveyor belt, the plate or the frame without any problems. This means that in many situations it is necessary to manually align and hold the transport cart in order to be able to move the loading device underneath it. However, such a manual alignment is in many cases not possible at all, or only with very great deal of effort, especially with a fully loaded transport cart. Furthermore, the transport cart of the known transport and loading system is relatively cumbersome in its handling and, in particular, in the case of the use of the transport cart on stairs or in elevators, it is essentially entirely unsuitable.

The object of the invention is to avoid the above-mentioned disadvantages in a generic transport and loading assembly and to enable simple and convenient unloading and loading of the transport cart into and out of the loading area, as well as convenient handling.

This object is achieved by means of a transport and system with the characteristics of claim 1. In this case, for adjusting the height of the transport cart or for adjusting the vertical distance from at least three rolling means, the chassis has an at least partially telescoping linkage with at least three telescoping devices which can be fully automatically, partially automatically adjusted independently of one other, on each of which one of the rolling means is held. In this way, it is possible to adjust the height of the transport cart or transport container, in particular steplessly, and at the same time fix the chassis stably at the height set in each case. In addition to the height adjustment relative to the loading device or relative to the loading area of the relevant motor vehicle for better loading, it is also possible to adjust the height of the transport cart to the height of the respective user in the transport position. This allows convenient handling, regardless of the height of the user, also when transporting objects with the transport cart. The at least partially telescoping linkage with at least three telescoping devices that can be adjusted independently of one another enables, in addition to the pure height adjustment of the transport cart, an adjustment of the alignment of the transport container to the alignment of the motor vehicle and its loading area. This horizontal alignment can be carried out with respect to two mutually perpendicular horizontal spatial axes, such as in a longitudinal direction and a transverse direction of the transport cart.

It is particularly advantageous if each rolling means for adjusting the vertical distance relative to the transport container is held on its own telescoping device, whereby the transport cart or transport container can be aligned with respect to both horizontal spatial axes relative to the loading area or its loading edge in order to enable problem-free gripping and loading of the transport cart by the loading device.

In a particularly preferred embodiment, a sensor arrangement acts between the loading device and the transport cart, depending on whose signal the height of the transport cart relative to the loading device can be automatically adjusted in a predetermined manner. In this way, an optimum height of the transport cart relative to the loading device for picking up and loading can be set essentially automatically.

Advantageously, the height adjustment device can be used to set a different vertical distance between the transport container and at least two spaced-apart rolling means or wheels. In this way, in addition to simply adjusting the height of the transport cart, it is also possible to align the transport container horizontally with respect to the loading device or to adapt the position of the transport container to the alignments of the loading device. This means, for example, that even if the motor vehicle and/or the transport cart are aligned at an angle as a result of an uneven surface, the transport cart can still be held stably on the loading device.

It is also advantageous if the loading device is provided with a guide aid for the transport cart, which acts in the vertical direction and against which the transport cart can be placed in a docking position. The guide aid serves on the one hand as a stop for secure positioning of the transport cart relative to the loading device or relative to the motor vehicle. In addition, the guide aid serves for precise vertical guidance during adjustment of the height of the transport cart or during alignment of the transport container relative to the loading device.

In this case, the guide aid is advantageously held pivotable on the loading device so that it can be swiveled horizontally and can be docked against a corner area of the transport container formed by two side surfaces in an encompassing manner. Such a swiveling guide aid, which encompasses the corner area in question at an angle, can ensure particularly precise vertical guidance. Particularly in the case of a paired arrangement of two such guide aids that can be turned towards each other, a certain centering relative to the loading device can also be achieved when the transport cart is positioned.

Advantageously, a chassis receiving area is provided on the transport cart in which the chassis can be at least partially received in the loading position. In this way, the chassis can be received at least partially within the outer contour of the transport vehicle during loading and transport in the loading area, for example.

Preferably, the chassis receiving area has at least one telescoping receiving area into which the at least one telescoping device can be at least partially retracted in the loading position. By means of such a telescoping receiving area for receiving at least one telescoping device, the chassis can be moved at least partially into a particularly space-saving position, such as within the outer contour of the transport cart, during loading and during transport in the loading area.

In addition, the loading device advantageously has engagement means which can be displaced to an extension position outside the loading area in order to establish or release a positive locking and/or frictional locking connection with the transport cart. This allows the transport cart to be fixed at a distance from the relevant motor vehicle relative to the loading device in order to initiate a loading operation, or to be released in order to complete an unloading operation. In this way, it can be ensured that no damage to the motor vehicle is caused by contact with the transport cart during the entire loading operation of the transport cart.

In this connection, it is convenient if the engagement means are held on at least one extendable loading part of the loading device, on which the transport container can be supported in a support position of the transport cart in the direction of gravity. This allows the transport cart to be held at least partially independently of the chassis so that the latter can be moved at least partially into the loading position after the connection between the transport cart and the engagement means has been established, or the telescoping linkages can be moved at least partially into the telescoping receiving areas. The extendable loading part can be adjusted relative to the rest of the loading device by any known and suitable type of drive, such as an electric gear/rack and pinion or belt drive, a hydraulic drive and/or any other linear drive.

It is advantageous if, in addition to the positive locking and/or frictional locking connection to the transport cart, the engagement means can also be used to secure the transport cart in the loading position in the opposite direction to the direction of gravity. In this way, the transport cart can be secured to the loading device in all directions in the loading position, which enables safe and quiet transport of the transport cart received in the loading area in the loading position.

Advantageously, the engagement means are formed on a loading cart which can be displaced by a motor on the extendable loading part. A motor-driven loading cart with engagement means of this type can thus be used to automatically and safely pull the transport cart into the loading area of the motor vehicle during loading or push it out of the loading area during unloading. The at least one loading cart can be displaced on the loading part or relative to the rest of the loading device by any known and suitable type of drive, such as an electric gear/rack and pinion or belt drive, a hydraulic and/or other linear drive.

It is convenient, for example, if the loading cart has a hollow profile with a longitudinal slot at the top, which can rear-engaged by a rear-engaging element on the transport cart side, or vice versa. This makes it particularly easy to establish the positive locking and/or frictional locking connection between the loading cart and the transport cart, whereby the transport cart can also be securely fixed in the vertical direction relative to the loading device, in particular, by means of the rear-engaging connection.

Alternatively, the engagement means can also have a locking mechanism that can be switched manually, partially or fully automatically between a release position and a locking position, by means of which the positive locking and/or frictional locking connection between the loading cart and the transport cart, acting in the vertical and/or horizontal direction, can be established.

In addition, it is advantageous if the loading device has at least one support area which extends in a loading direction and along which displaceable support means of the transport cart can be moved, such as rollers, rolls, sliding bearings, or other displaceable support means. This allows the transport cart to be moved along the loading device without problems and with low noise, even with a high loading weight, in order to be loaded or unloaded.

In another particularly preferred embodiment, the transport container has at least two separable or connectable partial containers. This enables adapted use of the transport container depending on the transport parts to be received or the purchases. In this case, the two partial containers advantageously have two side walls that can be docked against each other on the end face, whereby both side walls can be fixed to each other via connecting means and connecting countermeans, which in turn can be detached from each other by a mutual horizontal displacement. This makes it particularly easy and, in particular, automatic for the loading device to connect or separate the two part holders.

Furthermore, it is advantageous if the transport container can be detachably fixed to the chassis in order to hold it securely to the chassis during transport by means of the chassis on the one hand and to be able to handle or carry it independently of the chassis on the other.

In a particularly preferred embodiment, the chassis has at least two partial chassis that can be separably connected to each other by locking means. This allows the transport cart to be adapted in size according to need or application.

It is advantageous if at least one of the partial chassis is provided with, for example, a fold-out or fixed support chassis. In this way, even if only a partial chassis separated from the rest of the chassis is used, the latter can be made stable or movable in an upright position.

In addition, it is advantageous if the loading device also has two loading parts that can be extended independently of one another, on each of which one of the partial containers can be supported in the direction of gravity and each of which has engagement means for establishing or releasing the positive locking and/or frictional locking connection with one of the partial containers. In this way, both partial supports or partial chassis can be displaced independently of one another by the loading device. This allows them to be loaded and unloaded independently of one another or to be connected and disconnected from each other by relative movement of the connecting means and connecting countermeans.

Preferably, the height adjustment device is electrically operated and has at least one accumulator device. This allows the height of the transport cart to be conveniently adjusted to the height or alignment of the loading device or to the height of the user.

Advantageously, the transport cart comprises electrical connecting means connected to the accumulator device. In addition, connecting countermeans are provided on the loading device, which can be connected to an electrical power supply of the motor vehicle. The connecting countermeans can be contacted by the electrical connecting means in a fixing position of the transport cart on the loading device. In this way, the accumulator device of the transport vehicle can be charged by the electrical power supply of the motor vehicle in its fixing position in the loading area.

Alternatively or in addition to this, second electrical connecting means can be provided on the transport cart, which can be connected to the vehicle-side connecting countermeans and via which a cooling unit of the transport cart can be supplied with electrical power. In this way, a cooling container can be provided in the transport container, which can be cooled in the fixing position of the transport cart by means of the cooling unit and the electrical power supply of the motor vehicle. Alternatively or in addition to the refrigerated container, an electric food preparation or heating device may also be provided, such as a microwave oven, an electric stove, or an oven.

It is also convenient if the transport cart has a traction drive by means of which it can be moved automatically. This means that even heavier loads of objects picked up at the transport container can be conveniently transported by means of the transport cart.

In addition, the transport cart can advantageously have a traction assistance system to also enable automatic control and thus autonomous moving of the transport cart.

In addition, it is convenient if the transport cart has a lighting device, such as a spotlight or illuminated sign. In this way, the accumulator device carried on the transport cart can be used for other functions.

It is also advantageous if the transport container, or the partial containers forming it, is or are designed to be foldable. This allows the transport container to be carried along in the loading area in a particularly compact manner when empty, as in the loading position or the fixing position.

In another advantageous embodiment, a goods registration and/or payment device is provided on the transport cart, which may comprise, for example, a display, a scanner, a payment app, a card reader. In this way, the transport cart enables convenient recording of the goods placed in the transport container and/or a particularly simple payment process. In this way, it is possible, for example, to pay for goods placed in the transport container during a shopping trip without having to remove the goods from the transport cart again for the payment process.

Furthermore, it is convenient if an integrated rain cover is provided on the transport cart, by means of which the transport container and the transport items received therein can be covered.

Moreover, the above-mentioned object is achieved by the transport cart 10 of the transport and loading assembly 2 in one of the above-mentioned embodiments by itself. Moreover, the above-mentioned object is achieved by the loading device of the transport and loading assembly 2 in one of the above-mentioned embodiments by itself.

Furthermore, the above-mentioned object is achieved by a loading method in which the transport and loading assembly is used in one of the above-mentioned embodiments and in which, in a first step, the transport cart is approximated to the loading device installed in the motor vehicle and, in a second step, a position of the transport cart, such as in particular its height and/or alignment with respect to the loading device is determined, wherein in a third step, as a function of the determined position, a docking position of the transport cart is automatically set, in which the transport container is arranged with respect to the loading device in a predetermined manner, such as in particular with respect to its height and/or alignment. This allows the transport cart to be aligned with respect to the motor vehicle even in the event of non-uniform height and/or alignment with respect to the motor vehicle, for example as a result of an uneven or non-uniform base surface, in such a way that a loading operation, in particular a partially or fully automatic loading operation, can be started by means of the loading device.

Advantageously, in the third step, the distances of at least two, at least three or four or all of the rolling means, respectively, can be adjusted with respect to the transport container so as to precisely match the height and alignment of the latter to the motor vehicle or the loading device accommodated therein.

In addition, it is convenient if, in a fourth step, the transport cart is moved from the docking position to a support position in which it is supported on the loading device in the direction of gravity GR. In this way, the weight of the transport cart or of the transport container filled with transport items, for example, can be partially received by the loading device and the motor vehicle in order to partially relieve the transport chassis and thereby prepare it for loading.

In the support position, the positive locking and/or frictional locking connection between the transport cart and the displacement device is established, so that in a fifth step a part of the chassis facing the motor vehicle is displaced into the chassis receiving area. In this way, when the transport cart is set down on the loading device, the positive locking and/or frictional locking connection required for the automatic loading operation is also produced, by means of which the transport cart can be displaced into or out of the loading area.

In addition, it is advantageous if, in a sixth step, the transport cart can be displaced by means of the loading device with the chassis partially received in the chassis receiving area and a part of the chassis supported on the base surface and facing away from the motor vehicle, as a result of which the weight of the transport cart is still partially transferred via the chassis also during the loading operation into or out of the loading area, as long as the transport cart is not yet stably mounted or as soon as it is no longer stably mounted on the loading device.

Advantageously, the part of the chassis supported on the base surface is adjusted during the sixth step to compensate for a vertical displacement that occurs, for example, due to lowering of the motor vehicle as a result of the shifting of the weight of the transport cart or due to a vertical displacement of the rolling means as a result of an unevenness of the base surface. The vertical displacement can be determined, for example, by a pressure or inclination sensor system, whereby the distance between the rolling means and the transport container is adjusted or controlled as a function of a signal from this sensor system in order to maintain the set alignment of the transport container relative to the loading device.

In this way, the transport cart can be loaded without any problems even with a larger received weight and on uneven base surface.

It is convenient if, in a seventh step following the sixth step, the transport cart is moved into the loading position, in which the part of the chassis facing away from the motor vehicle is also displaced into the chassis receiving area, as soon as the transport cart has been displaced into the loading area to such an extent that it rests stably on the loading device. In the loading position, the transport cart can thus be displaced in a particularly compact position within the loading area.

Furthermore, in an unloading operation following the first to seventh steps, the transport cart is again displaced out of the loading area against the loading device V, whereby, in reverse order, the part of the chassis facing away from the motor vehicle is now extended first and then the part facing the motor vehicle, so that the weight of the transport cart can be gradually removed again via the chassis on the base surface.

Here it is particularly advantageous if the chassis is extended and brought into the docking position in response to the signal from a pressure or position sensor, so that it can also be brought into the docking position safely and partially or fully automatically during unloading.

It is pointed out that all the above-described features of the object according to the invention can be interchanged or combined with one another, providing an interchange or combination thereof is not precluded for technical reasons.

An exemplary embodiment of the invention is shown in the figures. The drawings show the following:

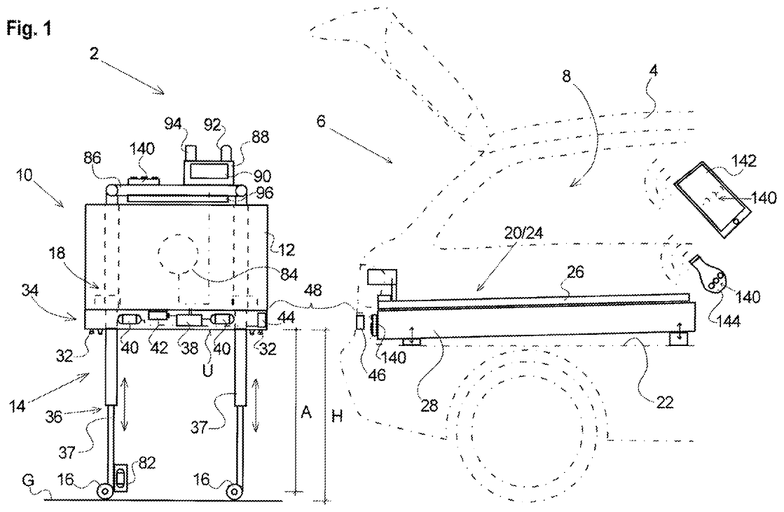

FIG. 1 a side view of a transport and loading assembly according to the invention with a transport cart in transport position,

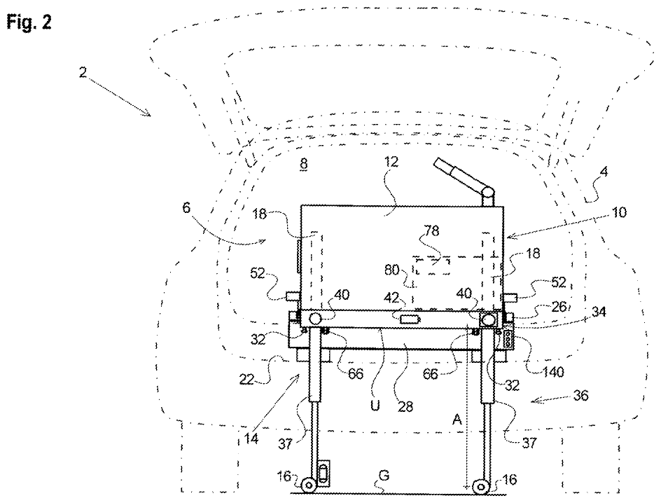

FIG. 2 a rear view of the transport and loading assembly according to FIG. 1,

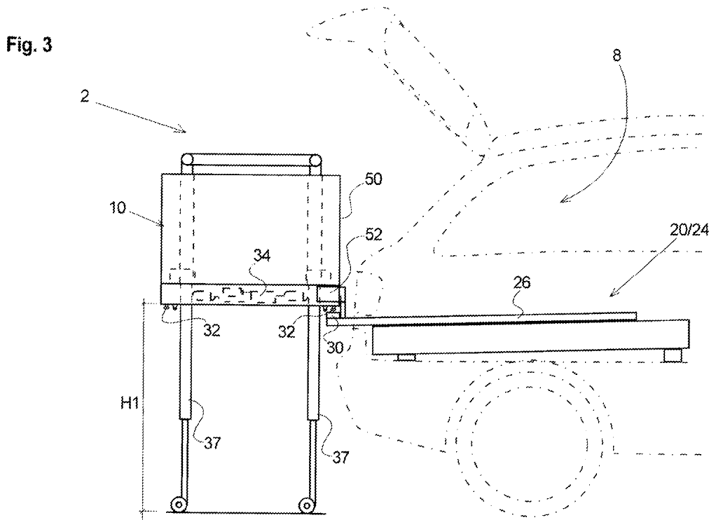

FIG. 3 a side view of the transport and loading assembly according to FIG. 1 before a positive locking and/or frictional locking connection is made,

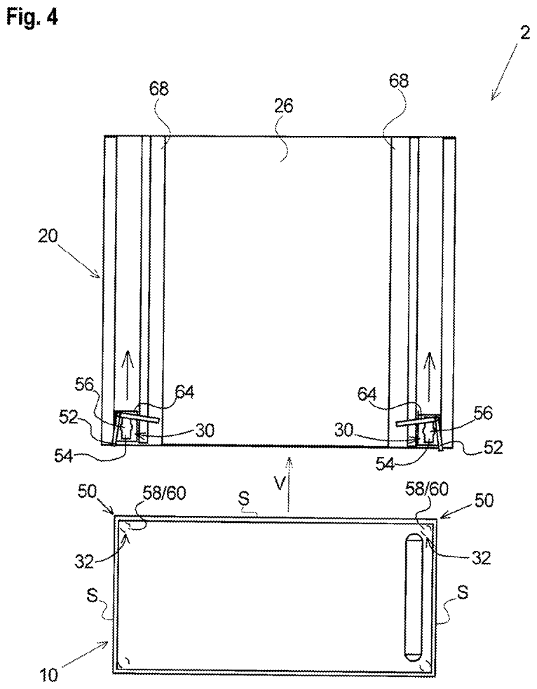

FIG. 4 a top view of the transport and loading assembly according to FIG. 1,

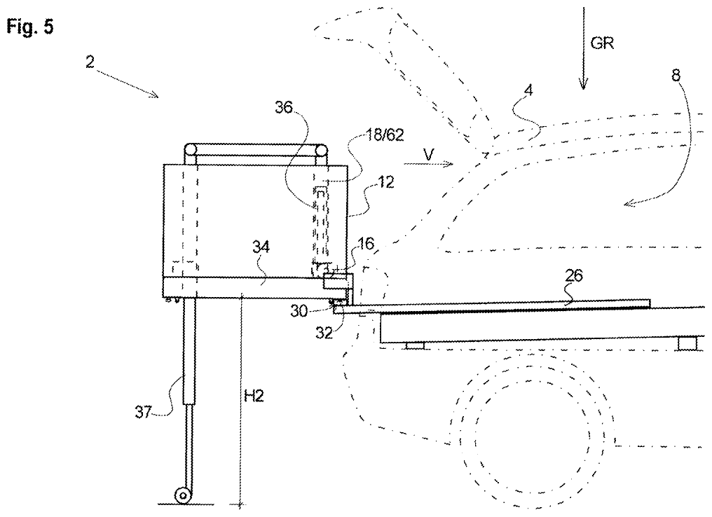

FIG. 5 a side view of the transport and loading assembly according to FIG. 1 when the positive locking and/or frictional locking connection is made,

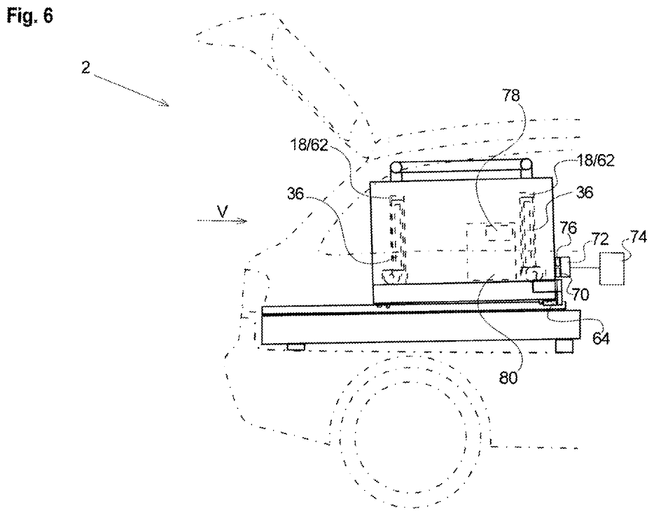

FIG. 6 a side view of the transport and loading assembly according to FIG. 1 in a fixing position,

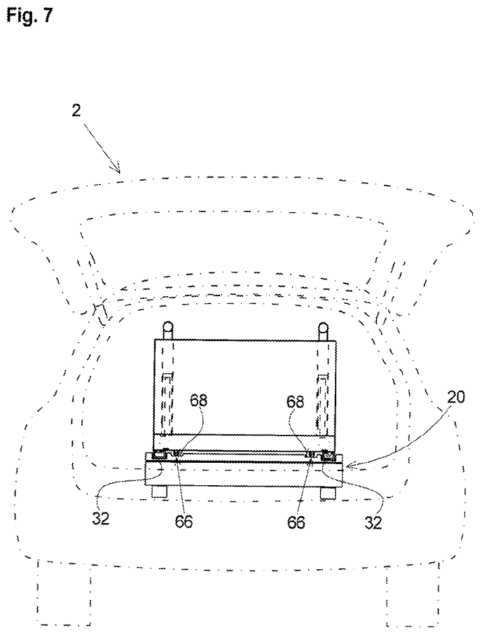

FIG. 7 a rear view of the transport and loading assembly according to FIG. 6,

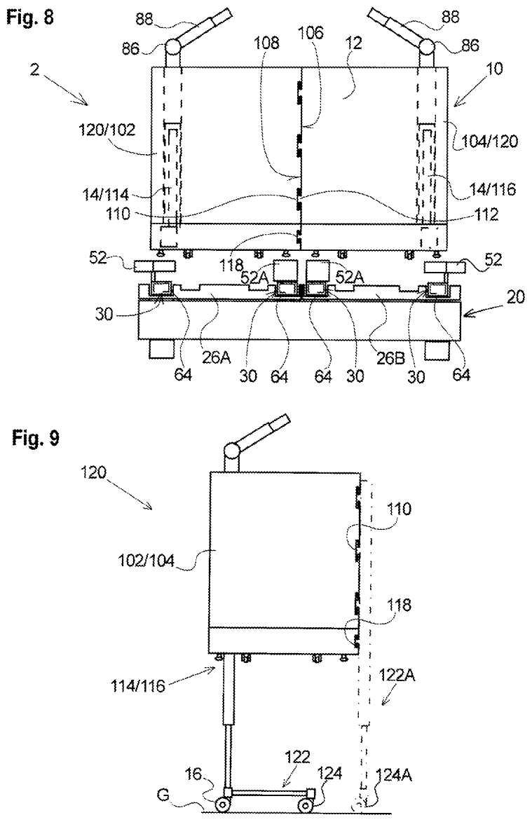

FIG. 8 a rear view of the transport and loading assembly in an alternative embodiment,

FIG. 9 a side view of a partial cart of the transport and loading assembly according to FIG. 8

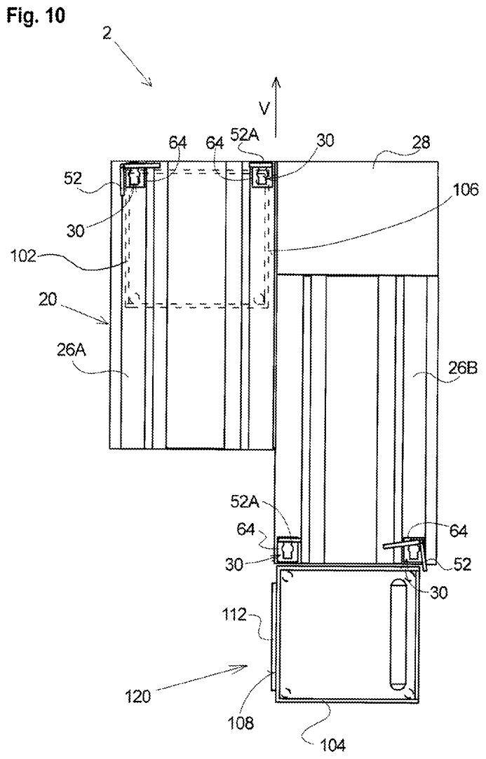

FIG. 10 a top view of a loading device of the transport and loading assembly according to FIG. 8 and

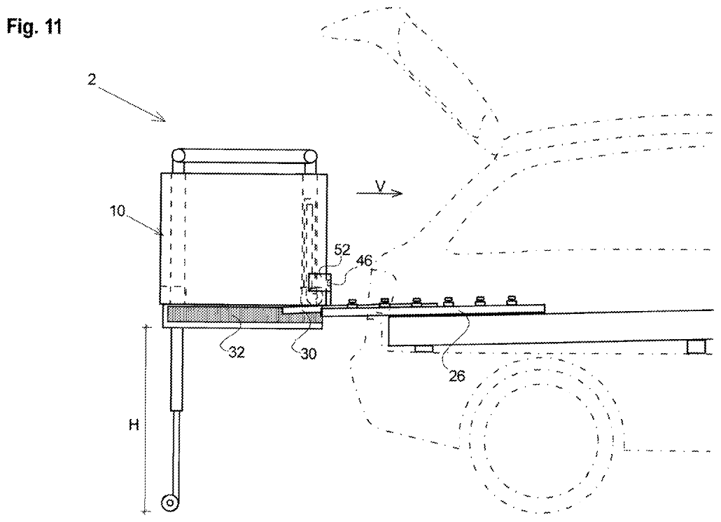

FIG. 11 a side view of the transport and loading assembly in a further alternative embodiment.

FIGS. 1 and 2 show a transport and loading assembly 2 for a motor vehicle 4 in the exemplary form of a passenger car of SUV design with a loading area 8 accessible via a rear opening 6.

In this context, the transport and loading assembly 2 has a transport cart 10 with a transport container 12, which is held in particular in a removable manner on a chassis 14 with, for example, four rolling means 16. The rolling means 16 can be designed as single rollers or, alternatively, as rollers arranged in pairs or as multiple rollers. In any case, the rolling means 16 are adjustable via the chassis 14 between a transport position shown and a loading position. In the transport position, the transport cart 10 can be parked and moved on a base surface G via the rolling means 16. In the loading position, the chassis 14 is docked against the transport container 12 or at least partially displaced into a chassis receiving area 18 provided on the transport container 12. This provides the transport cart 10 with reduced external dimensions for a loading operation.

Both the transport container 12 and the chassis 14 may be made of any materials known and suitable for the manufacture of transport carts 10. In particular, they can be made at least in part from a metal, plastic, glass or carbon fiber material, or combinations thereof.

In addition, the transport and loading assembly 2 has a loading device 20 that is accommodated on a load floor 22 of the loading area 8. This forms a loading mechanism 24, which allows the transport cart 10 to be loaded into or unloaded from the loading area 8 of the motor vehicle 4. For this purpose, the loading device 20 has a loading part 26 which can be extended out of the loading area 8, such as a plate, a carrier or telescoping arm or a rail, the loading part 26 being displaceably held on a bearing plate 28 which can be placed on the load floor 22. The bearing plate 28 can advantageously be designed to be height-adjustable so that it can be lowered deep into the loading area 8 alone or in conjunction with the loading device 20, for example, when not in use. In addition, engagement means 30 are provided on the loading device 20 to provide a positive locking and/or frictional locking connection to the transport cart 10. For this purpose, the engagement means 30 serve to establish a positive or frictional connection with engagement countermeans 32 of the transport cart 10 and are held, for example, as shown in FIG. 3, on the loading part 26 of the loading device 20. Together with the loading part 26, the engagement means 30 can thereby be displaced to an extension position outside the loading area 8. The engagement countermeans 32 may be formed by separate positive-fitting means projecting from an underside U of the transport cart 10, as shown in FIGS. 1 and 2. Alternatively, however, the engagement countermeans 32 may also be formed by existing or integrated areas or parts of the transport cart 10 that enable a positive locking and/or frictional locking connection with the correspondingly adapted engagement means 30 of the loading device 20. Alternatively or in addition thereto, the engagement means 30 or engagement countermeans 32 can also have a locking mechanism which can be switched manually, partially or fully automatically between a release position and a locking position, by means of which the connection can be produced between the loading device 20 and the transport cart 10, which acts in the vertical and/or horizontal direction and is positive locking and/or frictional locking (not shown).

In order to be able to establish the positive locking and/or frictional locking connection between the loading device 20 and the transport cart 10, which is required for a convenient loading operation without problems, the transport cart 10, as shown in FIGS. 1 and 2, has a height adjustment device 34, which is integrated in the transport container 12, by way of an example, but can alternatively also be held on the chassis 14. This can be fully automatically, partially automatically or manually operated and, in the transport position of the chassis 14, enables the adjustment of a height H of the transport cart 10 relative to the respective base surface G or the alignment of the underside U of the transport container 12 relative to the loading device 20. Here, the vertical distance A between the transport container 12 and the individual rolling means 16, which is essentially formed by the chassis 14, is adjusted.

In this regard, the chassis 14 has an at least partially telescoping linkage 36 that connects the rolling means 16 to the transport container 12. For setting the respective desired distance A, the height adjustment device 34 also has a control device 38, by means of which at least one electric actuator 40 can be controlled partially or fully automatically, which is used to adjust the at least one telescoping linkage 36. Preferably, at least two rolling means 16, in particular at least three or four or all rolling means 16 are held on a separate telescoping device 37 in order to be able to set different vertical distances A on these, fully automatically, semi-automatically or manually. Hereby, in addition to the adjustment of the height H, the alignment of the transport container 12 with respect to the loading part 26 can also be adjusted, which may be necessary, for example, in case of a certain inclination of the motor vehicle 4 and/or of the transport cart 12, such as, for example, as a consequence of an uneven base surface G.

In order to be able to supply the height adjustment device 34 with electrical energy independently of the motor vehicle 4, the latter has an accumulator device 42. Furthermore, the height adjustment device 34 preferably has a sensor device 44 which, together with sensor means 46 on the loading device 20 or on the rear opening 6 of the motor vehicle 4, forms a sensor arrangement 48 acting between the transport cart 10 and the loading device 20. This is used for the automatic detection of mutual heights and/or alignments and for the transmission of corresponding information or signals. Depending on the signals from the sensor arrangement 48, the control device 38 can set the telescoping devices 37 to different lengths in order to set the desired height H of the transport cart 10 and alignment of the transport container 12 relative to the loading device 20 or relative to a loading edge of the loading area 8.

To load the transport cart 10, it is approached in a first step in its transport position to the loading device 20 in loading direction V as shown in FIG. 4. By means of the sensor arrangement 48, the position of the transport cart 10 relative to the motor vehicle 4 is then determined in a second step. In a third step, the height adjustment device 34 is then used to automatically adjust the height H of the transport cart 10 relative to the respective base surface G or to align the underside U of the transport container 12 relative to the loading device 20 in order to bring the transport cart into a docking position as shown in FIG. 3. For this purpose, the vertical distance A between the transport container 12 and the individual rolling means 16, which is essentially formed by the chassis 14, is adjusted.

In this case, the height adjustment device 34 can be used, for example, to set a first height H1 of the underside U of the transport cart 10 relative to the base surface G as shown in FIG. 3, at which two corner regions 50 of the transport container 12 can each be docked against a guide aid 52 of the loading device 20. As can be seen from FIG. 4, the guide aids 52 are each formed by an exemplary angular element which is held in a pivotable manner and which encompasses the respective corner region 50 and can be docked against both side surfaces S forming the respective corner region 50. Due to the horizontally pivoting guide aids 52, the transport container 12 is centered between the guide aids 52 at the set first height H1 of the underside U according to FIG. 3 and can then be adjusted in a guided manner in the vertical direction. For optimum detection of the respective current height H of the transport cart 10 or the current height H1 of its underside U, the sensor means 46 of the sensor arrangement 48 can also be integrated in the guide aids 52, for example.

As can also be seen from FIG. 3, the guide aids 52 are positioned and the first height H1 is selected in such a way that the engagement countermeans 32 are arranged exactly above the engagement means 30. As shown in FIG. 4, the engagement means 30 are formed by way of an example by a longitudinal slot 54 which can be rear-engaged from above and on which an entry extension 56 is formed. This has slightly larger dimensions than a respective rear-engaging element 58 of the engagement countermeans 32, which in turn is formed by way of an example by a screw head 60, such as a pan head, countersunk head or hammer head.

In a fourth step, the height adjustment device 34 can be used to move the transport cart 10 from the docking position shown in FIG. 3 to a support position in which a second height H2 of the underside U is set as shown in FIG. 5. In this, the engagement means 30 is applied to the engagement countermeans 32 and the respective rear-engaging element 58 enters the entry extension 56 of the longitudinal slot 54. This supports the transport container 12 in the direction of gravity GR from the loading part 26, on which the engagement means 30 are mounted. As a result, the telescoping devices 37 arranged adjacent to the motor vehicle 4 with the rolling means 16 held thereon can now be displaced into the chassis receiving area 18 in a fifth step. Preferably, this has appropriately dimensioned telescoping receiving areas 62 to completely receive the wall linkages 36.

As can be seen in particular from FIG. 4, the engagement means 30 are formed on two loading carts 64 which are displaceable from the extended position according to FIGS. 2 and 4 along the loading part 26 into the loading area 8. During this displacement, the respective rear-engaging element 58 engages behind the relevant longitudinal slot 54 and comes into a stop position thereon, so that a positive locking connection is established between the engagement means 30 and the engagement countermeans 32 in the loading direction V, and the transport container 12 is pulled into the loading area 8 by the loading slides 64 from the position shown in FIG. 5 in a sixth step. Here, the weight of the transport cart 10 is supported in part on the loading device 20 and in part on the base surface G via the still extended telescoping devices 37 of the part of the chassis 14 facing away from the motor vehicle and the relevant rolling means 16.

During the further loading operation, the telescoping devices 37 facing away from the motor vehicle 4 are also moved into the telescoping receiving areas 62 provided for this purpose in a seventh step before coming into contact with the motor vehicle 4, so that the transport cart 10 then assumes the loading position shown in FIG. 6, in which its weight is fully supported on the loading device 20.

In this case, the rear-engaging connection between the engagement means 30 and the engagement countermeans 32 also acts counter to the direction of gravity GR as a means of securing the position of the transport container 12 that is in contact with the loading part 26. This makes it possible, with the displacement of the loading cart 64, to also displace the remaining telescoping devices 37 into the chassis receiving area 18 or into the telescoping receiving areas 62 provided for them. After this, the chassis 14 and the transport cart 10 as a whole are in the loading position, as shown in FIG. 6. When an end position is reached, the loading cart 64 and/or the transport cart 10 are additionally fixed with respect to the loading device 20 or with respect to the motor vehicle 4, respectively, and are thus in a fixing position that ensures safe and positionally stable transport of the transport cart 10 with the motor vehicle 4.

In order to ensure a problem-free loading operation into the loading area 8 even in the case of a high transport weight of the transport cart 10, additional displaceable support means 66 can be provided on the underside U of the transport container 12 in addition to the engagement countermeans 32, as can be seen in particular from FIGS. 2 and 7. These displaceable support means 66 may, for example, be in the form of rollers, rolls or sliding bearings which are displaceable along a corresponding, for example rail-like, support region 68 which extends over the loading device 20 in the loading direction V, as can be seen in particular from FIG. 4.

As can be further seen from FIG. 6, electrical connecting means 70 may be provided on the transport cart 10, which are connected to the accumulator device 42 and contact connecting countermeans 72 in the fixing position in the loading area 8. The connecting countermeans 72 are in turn in communication with an electrical power supply unit 74 of the motor vehicle 4, such as a car battery and/or an alternator of the motor vehicle 4. In this way, the accumulator device 42 of the transport cart 10 can be recharged on a recurring basis in the fixing position in the loading area 8.

Furthermore, second electrical connecting means 76 can be provided on the transport cart 10, which can also contact the connecting countermeans 72 of the motor vehicle 4 in the fixing position and are connected to a cooling unit 78 provided on the transport container 12. In this way, the cooling unit 78 can cool down a cooling box 80 removably received on or integrated in the transport container 12 whenever the transport cart 10 is in the fixing position in the loading area 8. Alternatively or in addition to the cool box 80, an appliance for preparing food, such as a microwave oven or an electric oven (not shown), may also be provided via the accumulator device 42 and/or via the connecting means 76.

The ability to recharge the accumulator device 42 on a recurring basis means that it can also be used to provide electrical power to other functional units. For example, the transport cart 10 according to FIGS. 1 and 2 can have a traction drive 82 for at least partially automatically moving the rolling means 16. In this case, the traction drive 82 can be controlled by the user themselves and/or via a traction assistance system, which is integrated in the control device 38, for example. In addition, the transport cart 10 may include a lighting device 84 formed, for example, by a spotlight and/or an illuminated advertisement.

Furthermore, for example, a goods registration and/or payment device 88 may be provided on a handle 86 of the transport cart 10, by means of which the goods deposited in the transport container 12 may be registered, for example by means of a scanner 92, and displayed on a display 90. The display 90 can also be used to operate a payment app stored on the control device 38 or another computer device, by means of which the detected goods can also be paid for directly, for example by means of a bank account which has also already been stored and/or by means of a card reader 94. In this way, the goods no longer have to be removed from the transport container 12 for the payment process. The goods registration and/or payment device 88 may be removably attached to the transport cart 10 or permanently installed thereon, such as on the handle 86.

As a further feature, a rain cover 96 may also be provided on the transport cart 10 to cover the transport container 12, for example, the rain cover 96 being extendably integrated in the transport cart 10 such as on the handle 86. In addition, the handle 86 may be designed to be adjustable in height relative to the rest of the transport cart 10. FIG. 8 shows an alternative embodiment of the transport and loading assembly 2 with a transport cart 10 in the loading position, in which the transport container 12 is formed by two separable or connectable partial containers 102 and 104. In addition to this two-part design, the transport container 12 can alternatively be designed in three or more parts (not shown). In each case, the partial containers 102, 104 have two side walls 106, 108 that can be docked against each other and on which connecting means 110 and connecting countermeans 112 are provided. In this case, the connecting means 110 and connecting countermeans 112 are shaped in such a way that they can be pushed into one another by relative horizontal displacement with respect to one another in order to produce a positive connection. Furthermore, the existing positive connection can also be released in turn by relative horizontal displacement of the connecting means 110 and connecting countermeans 112 with respect to each other in order to be able to use the two partial containers 102 and 104 separately from each other, such as for a smaller goods transport or purchase.

As can also be seen from FIG. 8, the chassis 14 is divided into two separable partial chassis 114 and 116, which can be connected to each other via locking means 118, and to which the partial containers 102 and 104 are respectively held. In this regard, the goods registration and/or payment device 88 may, for example, be removable and thus selectively usable for one of the two partial containers 102, 104 or may be permanently installed on both partial containers 102, 104, such as on the handle 86.

In any case, by differing displacement of the two loading parts 26A, 26B, a partial cart 120 as shown in FIG. 9 can be separated, consisting only of one of the partial containers 102 and the associated one of the two partial chassis 114. In order to be able to ensure that the partial cart 120 can also stand stably with respect to the base surface G, a support chassis 122 is also provided on the relevant partial cart 114, which is held on the partial cart 114 such that it can be folded out, for example, and via which the partial cart 120 can be set down or moved on the base surface G via at least one additional rolling means 124. As an alternative to the fold-out embodiment of the support chassis 122 shown, this can also be designed as a detachable additional chassis 122A with additional rolling means 124A, as shown by dashed lines in FIG. 9, which can be attached to the relevant partial container 102, 104 and/or to the partial chassis 114, 116, such as by horizontal insertion in the connecting means or connecting countermeans 110, 112 and/or via the locking means 118.

For separating and connecting the two partial containers 102, 104 and partial carts 114, 116, two independently displaceable loading parts 26A, 26B are provided on the loading device 20, each of which interacts with one of the two partial carts 120 and for this purpose has two engagement means 30, loading carts 64 and guide aids 52, 52A, as can be seen in particular from FIG. 10. Appropriately, two engagement countermeans 32 and displaceable support means 66 are also provided on each of the partial containers 102, 104 of the partial carts 120, as can be seen in FIG. 9. In contrast to the two angular outer guide aids, the two centrally arranged guide aids 52A serve merely as a stop in the loading direction V and thus enable the connecting means and connecting countermeans 110, 112 or the locking means 118 to be connected or disconnected. In this way, only one of the two loading parts 26A; 26B of the loading device 20 can also be used to load and unload only one of the partial carts 120 in a stable and problem-free manner.

Regardless of whether the transport and loading assembly 2 is used with the integral transport cart 10 or the partial carts 120, the transport container 12 or the partial containers 102, 104 may be detachably connected to the respective chassis 14 or the partial chassis 114, 116, as required, so as to be used in the manner of a basket or other portable container. In a further embodiment, the partial containers 102, 104 may be fixable to the partial chassis 114, 116 in a position relatively close to the base surface to enable the partial carts 120 to be moved in the manner of a transport cart or wheeled suitcase (not shown). Furthermore, the transport container 12 or the partial containers 102, 104 may be provided with foldable side surfaces S or side walls 106, 108, respectively, to enable even more compact stowage of the transport cart 10 or the partial carts 120, respectively.

FIG. 11 shows another alternative embodiment of the transport and loading assembly 2, in which the engagement means 30 are formed by extendable gripper arms that interact with engagement countermeans 32 on the transport cart 10 in the form of toothed rails. The engagement means 30 are mounted in an extendable manner on two likewise extendable, rail-shaped loading parts 26, at the end of which, in addition, the vertical guide aids 52 are also held in a pivotable manner.

In this embodiment, the transport cart 10 is docked against the two guide aids 52 held in the extended position at the beginning of the loading operation or, as already described above, centered between them. The desired height H of the transport cart 10 is set depending on the sensor arrangement 48, which has sensor means 46 in the guide aids 52, for example. This height H is defined in such a way that the engagement means formed by the gripper arms can be moved away from the loading parts 26 in order to engage the toothed rails of the engagement countermeans 32, as shown, and thereby establish the positive locking and/or frictional locking connection.

In this position, the transport container 12 is supported on the loading device 20 in the direction of gravity GR, so that the telescoping devices 37 arranged adjacent to the motor vehicle 4 can be moved into the telescoping receiving area 62, as shown. This allows the gripper arms of the engagement means 30 to be displaced in the direction of the loading area 8, so that the toothed rails of the engagement countermeans 32 can now be gripped by motor-driven toothed wheels 130 arranged along the loading parts 26 in the loading direction V. By driving these gears 130, the transport cart 10 is thus loaded into the loading area 8, whereby the telescoping devices 37 facing away from the motor vehicle 4 are also moved into the telescoping receiving areas 62 provided for this purpose before coming into contact with the motor vehicle 4.

In addition, this embodiment can also include the connecting means 70 and second connecting means 76 described above, as well as a traction drive 82 and a goods registration and/or payment device 88.

Furthermore, fixing means can also be provided in this embodiment, by means of which the transport cart 10 can be secured in the fixing position relative to the loading device 20 or relative to the loading area 8, in order to ensure problem-free and positionally stable transport in the motor vehicle 4.

Regardless of the embodiment, the transport cart 10 or partial cart 120 received in the loading area 8 can also be unloaded again from the motor vehicle 4 in an unloading operation by extending the at least one loading part 26, 26A, 26B into the extended position and successively extending the telescoping devices 37 from the respective telescoping receiving areas 62 partially or fully automatically. For this purpose, for example, a sensor system, such as a pressure or inclination sensor system, can be provided by means of which contact of the rolling means 16 with the base surface G can be detected, so that the telescoping devices G concerned can be fixed at a suitable height H of the transport cart (not shown).

Furthermore, irrespective of the embodiment, the transport cart 10 or the partial carts 120 can also be aligned parallel to the loading direction V during the loading operation as an alternative to the position transverse to the loading direction V shown in the figures, depending on the size of the loading area. In the case of large motor vehicles 4, for example, two integral transport carts 10 can also be loaded in this way by means of the loading device 20 with the two loading parts 26A, 26B independently of one another and, for example, next to one another parallel to the loading direction V and held in the fixing position (not shown).

An operating device 140 is further provided for activation or direct control of the loading device 20 and/or the transport cart 10 by the user. As shown in FIG. 1, this can be positioned on the transport cart 10 or on the loading device 20 in a fixed or removable manner. Alternatively, the operating device 140 may be integrated on a car key 142 and/or implemented programmatically on a portable computing device 144, such as a smartphone. In any case, the user can control the loading mechanism 24 via the operating device. In doing so, the user can move the loading part 26 or one of the loading parts 26A, 26B between the extended position and the fixing position. In addition, the user can raise and lower the bearing plate 28, if necessary, between an operating position for the loading operation and a lowering position for space-saving accommodation at the load floor 22. Furthermore, by means of the operating device 140, the height adjustment device 34 can also be controlled directly by the user, if required, in order to adjust the height H of the transport cart 10 or the distance A between the transport container 12 and the rolling means 16.

The transport and loading device 2 can thus be operated or controlled both semi-automatically and fully automatically or also directly or manually during a loading operation, irrespective of the respective embodiment of the transport cart 10 and the loading device.

It should be noted that all of the above-described elements and features of the various embodiments of the object according to the invention can be interchanged or combined with one another, providing an interchange or combination thereof is not precluded for technical reasons.

1. A transport and loading assembly for a motor vehicle, comprising a loading area extending as far as a rear opening,
with a transport cart which has a chassis with multiple rollers and at least one transport container wherein the chassis can be adjusted between a transport position and a loading position,
and with a loading device which can be installed in the loading area and which has a loading mechanism for loading and/or unloading the transport cart into or out of the loading area,
wherein the transport cart has an electrically operated height adjustment device by means of which the height of the transport cart can be adjusted in the transport position, and
wherein the chassis has an at least partly telescoping linkage in order to adjust the height of the transport cart, and three rollers are held on a respective telescopic device, wherein the telescopic devices are adjustable independently of one another.

2. The transport and loading assembly according to claim 1, wherein each roller-is held on its own telescopic device in order to adjust the vertical distance relative to the transport container.

3. The transport and loading assembly according to claim 1, wherein a sensor arrangement is provided which acts between the loading device and the transport cart, and the height of the transport cart can be adjusted as a function of a signal from the sensor arrangement.

4. The transport and loading assembly according to claim 1, wherein a vertical distance of the transport container with respect to at least two rollers for aligning the transport container can be set differently by means of the height adjustment device.

5. The transport and loading assembly according to claim 1, wherein a guide aid acting in the vertical direction is provided on the loading device, against which guide aid the transport cart can be docked.

6. The transport and loading assembly according to claim 5, wherein the guide aid is held on the loading device in a horizontally pivotable manner and can be placed in an encompassing manner against a corner region, formed by two side surfaces, of the transport container.

7. The transport and loading assembly according to claim 1, wherein a chassis receiving area is provided on the transport cart, in which receiving area the chassis can be at least partially received in the loading position.

8. The transport and loading assembly according to claim 7, wherein the chassis receiving area has at least one telescopic receiving area into which the at least one telescopic device can be at least partially retracted in the loading position.

9. The transport and loading assembly according to claim 1, wherein the loading device has an engagement mechanism which can be displaced into an extended position for establishing or releasing a connection to the transport cart which is positive locking and/or frictional locking.

10. The transport and loading assembly according to claim 9, wherein the engagement mechanism is held on at least one extendable loading part of the loading device, on which the transport container can be supported in the direction of gravity.

11. The transport and loading assembly according to claim 9, wherein, in addition to the positive locking and/or frictional locking connection to the transport cart, it is also possible to produce, via the engagement mechanism in the loading position, a securing of the transport cart which acts counter to the direction of gravity.

12. The transport and loading assembly according to claim 9, wherein the engagement mechanism is formed on a loading cart which is displaceable by motor on the loading part.

13. The transport and loading assembly of claim 12, wherein the loading cart has a top longitudinal slot that can be rear-engaged by a rear-engaging element on the side of the transport cart or vice versa.

14. The transport and loading assembly according to claim 1, wherein the loading device has at least one support region which extends in a loading direction and along which displaceable support means of the transport cart are movable.

15. The transport and loading assembly according to claim 1, wherein the transport container comprises at least two separable/connectable partial containers.

16. The transport and loading assembly according to claim 15, wherein the two partial containers have two side walls which can be placed against one another at the end faces, and the two side walls can be fixed to one another via connecting means and connecting countermeans which can be released from one another by mutual horizontal displacement.

17. The transport and loading assembly according to claim 1, wherein the transport container can be detachably fixed to the chassis.

18. The transport and loading assembly according to claim 1, wherein the chassis has at least two partial chassis which can be separably connected by means of lock.

19. The transport and loading assembly according to claim 18, wherein a support chassis is provided on at least one of the partial chassis.

20. The transport and loading assembly according to claim 15, wherein the loading device has two loading parts which can be extended independently of one another and on which in each case one of the partial containers can be supported in the direction of gravity and which in each case have an engagement mechanism for producing or releasing the connection to one of the partial containers which is positive locking and/or frictional locking.

21. The transport and loading assembly according to claim 1, wherein the height adjustment device comprises at least one accumulator device.

22. The transport and loading assembly according to claim 21, wherein the transport cart has electrical connecting means connected to the accumulator device, and connecting countermeans which can be connected to an electrical power supply unit of the motor vehicle are provided on the loading device and can be contacted by the electrical connecting means in a fixed position of the transport cart on the loading device.

23. The transport and loading assembly according to claim 21, wherein second electrical connecting means are provided on the transport cart, which means can be connected to the vehicle-side connecting countermeans and via which a cooling unit can be supplied with electrical current.

24. The transport and loading assembly according to claim 1, wherein the transport cart has a traction drive.

25. The transport and loading assembly according to claim 24, wherein the transport cart comprises a traction assistance system.

26. The transport and loading assembly according to claim 24, wherein the transport cart has a lighting device.

27. The transport and loading assembly according to claim 1, wherein the transport container is designed to foldable.

28. The transport and loading assembly according to claim 1, wherein a goods registration and/or payment device is provided on the transport cart.

29. The transport and loading assembly according to claim 1, wherein an integrated rain cover is provided on the transport cart.

30. A transport cart for use in the transport and loading assembly according to claim 1.

31. A loading device for use in the transport and loading assembly according claim 1.

32. A loading method using the transport and loading assembly according to claim 1, in which, in a first step, the transport cart is approximated to the loading device accommodated in the motor vehicle and, in a second step, a position of the transport cart with respect to the loading device is determined, wherein, in a third step, as a function of the determined position, a contact position of the transport cart is automatically set, in which the transport container is arranged with respect to the loading device in a predetermined manner, in which the height and orientation of the transport container with respect to the loading device are adapted.

33. The loading method according to claim 32, wherein in the third step the distances of at least two rollers are adjusted with respect to the transport container.

34. The loading method according to claim 32, wherein, in a fourth step, the transport cart is moved from the docking position to a support position in which it is supported on the loading device in the direction of gravity.

35. The loading method according to claim 34, wherein, in the supporting position, the positive locking and/or frictional locking connection between the transport cart and the displacement device is established and, in a fifth step, a part of the chassis facing the motor vehicle is displaced into the chassis receiving area.

36. The loading method according to claim 35, wherein, in a sixth step, the transport cart is displaced by means of the loading device with the chassis partially received in the chassis receiving area and a part of the chassis supported on the base surface and facing away from the motor vehicle.

37. The loading method according to claim 36, wherein the part of the chassis supported on the base surface is adjusted during the sixth step for compensating a vertical displacement in order to maintain the adjusted orientation of the transport container with respect to the loading device.

38. The loading method according to claim 36 or 37, wherein, in a seventh step following the sixth step, the transport cart is moved into the loading position in which the part of the chassis facing away from the motor vehicle is also displaced into the chassis receiving area.

39. The loading method according to claim 32, wherein, in an unloading process following the first to seventh step, the transport cart is displaced out of the loading area against the loading device and, in the process, first the part of the chassis facing away from the motor vehicle and then the part facing the motor vehicle are extended.

40. The loading method according to claim 39, wherein the chassis is extended and brought into the docking position in dependence on the signal of a pressure or position sensor system.
